(19) United States
(12) Patent Application Publication
(10) Pub. No.: US 2024/0372195 A1
(43) Pub. Date: Nov. 7, 2024

(54) BATTERY PACK ASSEMBLY HAVING SHOCK ABSORPTION FUNCTION AND APPARATUS AND METHOD FOR MANUFACTURING THE SAME

(71) Applicant: LG ENERGY SOLUTION, LTD., Seoul (KR)

(72) Inventors: Hak Soon KIM, Daejeon (KR); Jin Hyun LEE, Daejeon (KR); Jo Yeon HWANG, Daejeon (KR)

(73) Assignee: LG ENERGY SOLUTION, LTD., Seoul (KR)

(21) Appl. No.: 18/289,348

(22) PCT Filed: Dec. 16, 2022
(86) PCT No.: PCT/KR2022/020612

§ 371 Date: Nov. 2, 2023

(30) Foreign Application Priority Data
Jan. 13, 2022 (KR) 10-2022-0005308

(51) Int. Cl. H01M 50/242; H01M 10/04; H01M 50/105; H01M 50/211

(52) U.S. Cl. CPC H01M 50/242; H01M 10/0404; H01M 50/105; H01M 50/211

(57) ABSTRACT

Discussed is a battery pack assembly having a shock absorption function and an apparatus and method for manufacturing the same. The battery pack assembly can include a battery pack and a shock absorption member provided at one side of the battery pack. The shock absorbing member is capable of protecting the battery pack from shock.

### TECHNICAL FIELD

This application claims the benefit of priority to Korean Patent Application No. 2022-0005308 filed on Jan. 13, 2022, the disclosure of which is incorporated herein by reference in its entirety.

The present invention relates to a battery pack assembly having a shock absorption function and an apparatus and method for manufacturing the same, and more particularly to a battery pack assembly having a shock absorption function capable of absorbing or alleviating shock applied to a battery pack when the battery pack falls, thereby preventing physical damage to the battery pack, and an apparatus and method for manufacturing the same.

### BACKGROUND ART

Secondary batteries, which are energy sources substituting for fossil fuels causing air pollution, have been applied to an electric vehicle (EV), a hybrid electric vehicle (HEV), a plug-in hybrid electric vehicle (P-HEV), and an energy storage system (ESS).

There are a lithium ion battery, a lithium polymer battery, a nickel cadmium battery, a nickel hydride battery, and a nickel zinc battery as secondary batteries that are widely used at present. In general, a plurality of unit secondary battery cells may be connected to each other in series or in parallel to constitute a battery module depending on required output voltage or charge and discharge capacities.

In particular, usage of a pouch-shaped lithium ion battery having a structure in which a stacked type or stacked and folded type electrode assembly is mounted in a pouch-shaped battery case made of an aluminum laminate sheet has gradually increased due to advantages of low manufacturing cost and high energy density.

Meanwhile, with rapid technological development of mobile communication, popular interest in various kinds of mobile devices, such as a smartphone and a tablet PC, has increased. A secondary battery, which is capable of being charged and discharged, is mounted in each of the mobile devices. When the mobile device falls due to user carelessness, the secondary battery mounted therein may be damaged.

In particular, an electrolytic solution is injected into a pouch-shaped secondary battery. When a pouch is damaged, e.g. torn, due to shock, therefore, the electrolytic solution leaks from the battery, whereby the mobile device may be broken.

### PRIOR ART DOCUMENTS

Korean Patent Application Publication No. 2017-0055175
Korean Patent Application Publication No. 2016-0063763

### DISCLOSURE

### Technical Problem

The present invention has been made in view of the above problems, and it is an object of the present invention to provide a battery pack assembly having a shock absorption function capable of protecting a battery pack from physical shock, such as fall, and an apparatus and method for manufacturing the same.

### Technical Solution

A battery pack assembly according to the present invention to accomplish the above object includes a battery pack (110) and a shock absorption member (120) provided at one side of the battery pack (110).

Also, in the battery pack assembly according to the present invention, the shock absorption member (120) may include a polymer resin provided with an air pocket portion (121).

In addition, an apparatus for manufacturing a battery pack assembly according to the present invention includes a jig (200) filled with a polymer resin such that a shock absorption member (120) is formed at one side of a battery pack (110), a flat support unit (300) configured to support the battery pack (110) and the jig (200), the support unit having a predetermined area, and a hardening unit (400) configured to harden the polymer resin with which the jig (200) is filled, wherein the jig (200) includes a rectangular bottom plate (210) having a predetermined area, four side walls (220) extending along an edge of the bottom plate (210) by a predetermined height, an opening (230) provided in any one of the four side walls (220) such that one side edge of the battery pack (110) is seated on the bottom plate (210), and an air formation bar (240) located among the four side walls (220) in the state in which one side surface of the air formation bar is in tight contact with the bottom plate (210).

Also, in the apparatus for manufacturing the battery pack assembly according to the present invention, a plurality of jigs (200) may be seated on an upper surface of the support unit (300).

Also, in the apparatus for manufacturing the battery pack assembly according to the present invention, the support unit (300) may be rotatable in a clockwise direction or a counterclockwise direction, the support unit being formed in a circular shape, and one or more jigs (200) may be located upper surface of the support unit (300).

Also, the apparatus for manufacturing the battery pack assembly according to the present invention may further include a washing unit (600) configured to remove the polymer resin remaining in the jig (200) and the support unit (300) after the battery pack (110) having the shock absorption member (120) formed thereon is separated from the jig (200).

Also, in the apparatus for manufacturing the battery pack assembly according to the present invention, the polymer resin may be a UV curable resin.

In addition, a method of manufacturing the battery pack assembly according to the present invention includes a first step of seating the battery pack (110) on a jig (200), a second step of filling the jig (200) with a polymer resin such that the polymer resin is located along one side of the battery pack (110), and a third step of hardening the polymer resin such that a shock absorption member (120) is formed at the one side of the battery pack (110), wherein the jig (200) includes a rectangular bottom plate (210) having a predetermined area, four side walls (220) extending along an edge of the bottom plate (210) by a predetermined height, an opening (230) provided in any one of the four side walls (220) such that one side edge of the battery pack (110) is seated on the bottom plate (210), and an air formation bar (240) located among the four side walls (220) in the state in which one side surface of the air formation bar is in tight contact with the bottom plate (210), and the inside of each of the four side walls is filled with the polymer resin.

Also, the method of manufacturing the battery pack assembly according to the present invention may further include a fourth step of separating the battery pack (110) having the shock absorption member (120) formed thereon from the jig (200).

Also, the method of manufacturing the battery pack assembly according to the present invention may further include a fifth step of washing the jig (200) in order to remove the polymer resin remaining in the jig.

Also, in the method of manufacturing the battery pack assembly according to the present invention, the polymer resin may be a UV curable resin, and a step of printing an upper surface of the battery pack (110) with a UV curable material may be further performed between the first step and the third step.

Also, in the method of manufacturing the battery pack assembly according to the present invention, a step of inspecting the battery pack assembly may be further performed between the third step and the fifth step.

### Advantageous Effects

A battery pack assembly having a shock absorption function according to the present invention has an advantage in that a shock absorption member is provided at a battery pack, whereby it is possible to prevent or minimize damage to the battery pack even though physical impact due to fall, etc. occurs.

In addition, the battery pack assembly having the shock absorption function according to the present invention has a merit in that it is possible to prevent or minimize leakage of an electrolytic solution from the battery pack at the time of physical impact due to fall, etc., whereby it is possible to reduce damage to the device.

In addition, a battery pack assembly manufacturing apparatus and method according to the present invention have an advantage in that a plurality of jigs each configured to allow a shock absorption member to be mounted thereto is provided at a support unit, whereby mass production is possible and furthermore manufacturing time can be reduced.

### DESCRIPTION OF DRAWINGS

FIG. 1 is a conceptual view of a battery pack assembly according to a preferred embodiment of the present invention.

FIG. 2 is a perspective view of a jig configured to manufacture the battery pack assembly according to the preferred embodiment of the present invention.

FIG. 3 is a plan view of an apparatus for manufacturing the battery pack assembly according to the preferred embodiment of the present invention.

FIG. 4 is a front view of the apparatus shown in FIG. 3.

FIG. 5 is a plan view showing the state in which a plurality of jigs is mounted to one support unit.

FIG. 6 is a plan view showing the state in which a plurality of battery packs is mounted to respective jigs.

### BEST MODE

In the present application, it should be understood that the terms “comprises,” “has,” “includes,” etc. specify the presence of stated features, numbers, steps, operations, elements, components, or combinations thereof, but do not preclude the presence or addition of one or more other features, numbers, steps, operations, elements, components, or combinations thereof.

In addition, the same reference numbers will be used throughout the drawings to refer to parts that perform similar functions or operations. In the case in which one part is said to be connected to another part in the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a battery pack assembly having a shock absorption function according to the present invention and an apparatus and method for manufacturing the same will be described.

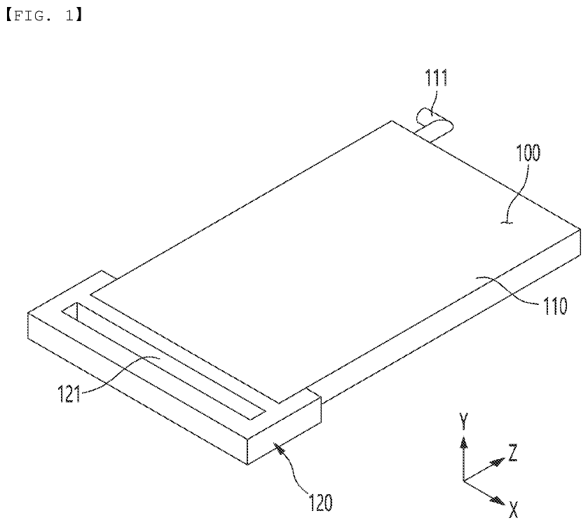

FIG. 1 is a conceptual view of a battery pack assembly according to a preferred embodiment of the present invention.

Referring to FIG. 1, the battery pack assembly according to the present invention has a function of protecting a battery pack when external shock is applied thereto.

Specifically, the battery pack assembly includes a battery pack 110 and a shock absorption member 120.

The battery pack 110 may have a flat hexahedral shape; however, the present invention is not limited thereto. An electrode assembly is received in a case, and a power connector 111 protrudes outwards from the case by a predetermined length.

A laminate sheet constituted by an outer coating layer, a metal layer, and an inner coating layer may be used as the case.

The inner coating layer is disposed in direct contact with the electrode assembly, and therefore the inner coating layer must exhibit high insulation properties and high resistance to an electrolytic solution. In addition, the inner coating layer must exhibit high sealability in order to hermetically seal the case from the outside, i.e. a thermally-bonded sealed portion between inner layers must exhibit excellent thermal bonding strength.

The inner coating layer may be made of a material selected from among a polyolefin-based resin, such as polypropylene, polyethylene, polyethylene acrylate, or polybutylene, a polyurethane resin, and a polyimide resin, which exhibit excellent chemical resistance and high sealability; however, the present invention is not limited thereto, and polypropylene, which exhibits excellent mechanical properties, such as tensile strength, rigidity, surface hardness, and impact resistance, and excellent chemical resistance, may be most preferably used.

The metal layer, which is disposed so as to abut the inner coating layer, corresponds to a barrier layer configured to prevent moisture or various kinds of gas from permeating into the battery from the outside. An aluminum thin film, which is lightweight and easily shapeable, may be used as a preferred material for the metal layer.

The outer coating layer is provided on the other surface of the metal layer. The outer coating layer may be made of a heat-resistant polymer that exhibits excellent tensile strength, resistance to moisture permeation, and resistance to air transmission such that the outer coating layer exhibits high heat resistance and chemical resistance while protecting the electrode assembly. As an example, the outer coating layer may be made of nylon or polyethylene terephthalate; however, the present invention is not limited thereto.

The electrode assembly received in the case may be classified as a stacked type electrode assembly, which is configured to have a structure in which a plurality of electrodes is stacked, a jelly-roll type electrode assembly, which is configured to have a structure in which a positive electrode and a negative electrode are wound in the state in which a separator is interposed therebetween, a laminated and stacked type electrode assembly, which is configured to have a structure in which a plurality of unit cells is stacked, or a stacked and folded type electrode assembly, which is configured to have a structure in which unit cells are wound in a state of being located on a separator sheet.

A unit cell is manufactured in order to manufacture the laminated and stacked type electrode assembly or the stacked and folded type electrode assembly. The unit cell may be a mono-cell, which is configured to have a structure in which a separator is interposed between a positive electrode and a negative electrode or a bi-cell, which is configured to have a structure in which a positive electrode, a negative electrode, and a positive electrode or a negative electrode, a positive electrode, and a negative electrode are stacked and a separator is interposed between the positive electrode and the negative electrode.

The electrode assembly according to the present invention may be configured to have a structure in which a negative electrode, a separator, a positive electrode, a separator, and a negative electrode are stacked, and the number of positive electrodes and negative electrodes constituting the electrode assembly may be freely set. In addition, the laminated and stacked type electrode assembly, in which a plurality of unit cells is laminated, may be used, and the structure of the electrode assembly may be applied to all electrode assemblies described in this specification.

The positive electrode and the negative electrode of the electrode assembly may be provided with a positive electrode tab and a negative electrode tab, respectively, and the pair of tabs may be formed so as to protrude outwards from the case by a predetermined length in a state of being connected respectively to a positive electrode lead and a negative electrode lead by spot welding or may be formed so as to protrude outwards through the power connector 111.

Here, an example of the power connector 111 may be a flexible printed circuit board (FPCB). The flexible printed circuit board (FPCB), which means a circuit board configured to have a structure in which a flammable film is formed on metal foil that is flexibly bent, such as copper foil, as an outer layer, is mounted in the battery pack 110 such that power and signals can be sent and received therethrough when the pack assembly 100 is mounted in a device.

The shock absorption member 120 is configured to absorb or alleviate shock applied to the battery pack 110 when the battery pack 110 falls in a state of being mounted in the device. In order to implement the above function, the shock absorption member 120 is provided at one side part of the battery pack 110, more specifically one side end surface and edge of the battery pack at which the power connector 111 is not provided.

Specifically, the shock absorption member 120 extends in a longitudinal direction (Z-axis direction) of the battery pack 110 by a predetermined length in a state of being fixed to one side end surface and a thickness-direction (Y-axis direction) side surface of the battery pack 110 in tight contact therewith.

Here, the shock absorption member 120 is not particularly restricted as long as the shock absorption member is flexible such that the shape of the shock absorption member is somewhat changeable, and an ultraviolet (UV) curing agent is contained in a polymer resin, such as an epoxy resin.

A bar-shaped air pocket portion 121, which is filled with no polymer resin, is provided at a position spaced apart from one side end surface of the battery pack 110 by a predetermined distance. Application of external shock to the battery pack 110 is inhibited or prevented by the air pocket portion 121.

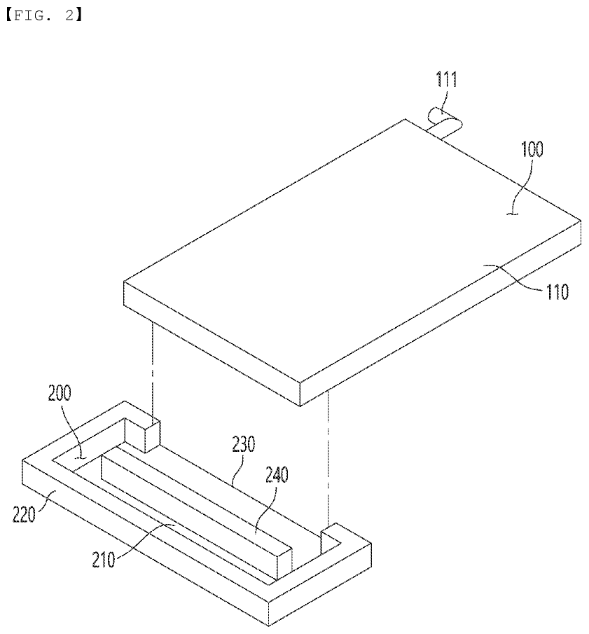

FIG. 2 is a perspective view of a jig configured to manufacture the battery pack assembly according to the preferred embodiment of the present invention.

The jig 200 configured to form the shock absorption member 120 at the battery pack 110 includes a bottom plate 210, a side wall 220, an opening 230, and an air formation bar 240.

Specifically, the bottom plate 210 is formed in a rectangular shape having a predetermined area, and four side walls 220 extend along an edge of the bottom plate 210 by a predetermined height.

It is preferable for the opening 230 to be provided in any one of the four side walls 220 such that one side edge of the battery pack 110 is seated on the bottom plate 210, and the air formation bar 240 is located among the four side walls 220 in a state of being in tight contact with the bottom plate 210.

One side part of the battery pack 110 is seated in the jig 200 having the above-described structure. When an inner space defined by the four side walls 220 is filled with a polymer resin and the polymer resin is hardened, a battery pack assembly 100 having a shock absorption member 120 attached to one side end surface and a part of an edge of the battery pack 110 in the state in which an air pocket portion 121 is formed in the middle of the shock absorption member is obtained.

Next, an apparatus for manufacturing the battery pack assembly according to the present invention will be described.

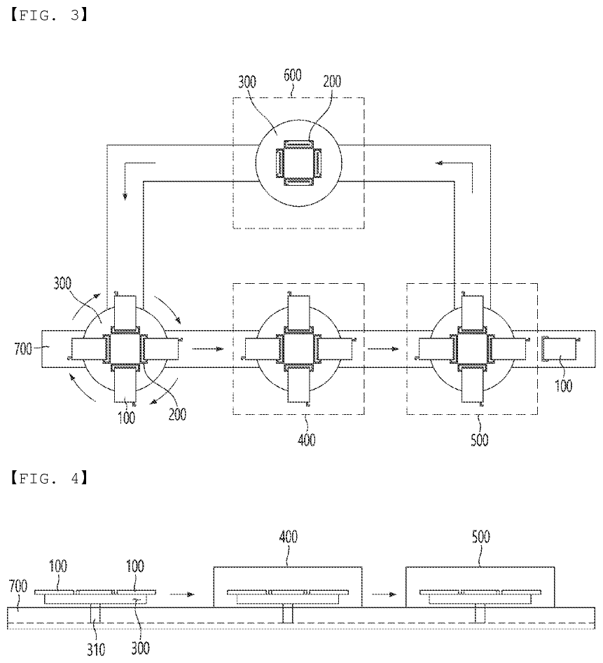

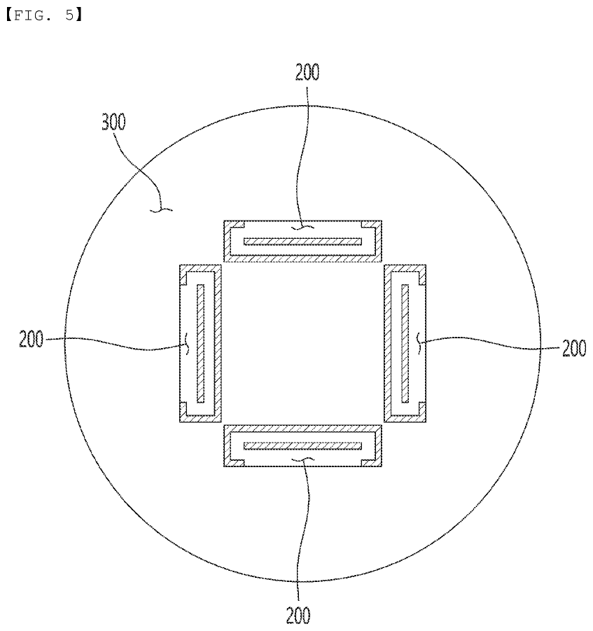

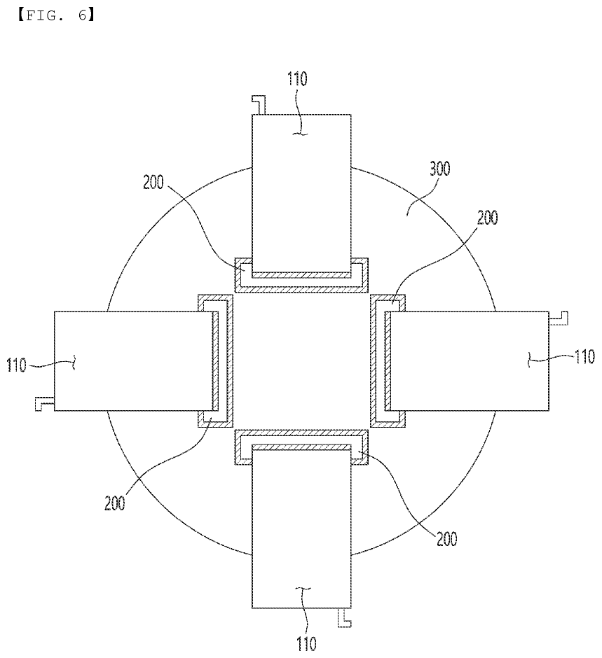

FIG. 3 is a plan view of an apparatus for manufacturing the battery pack assembly according to the preferred embodiment of the present invention, FIG. 4 is a front view of the apparatus shown in FIG. 3. In addition, FIG. 5 is a plan view showing the state in which a plurality of jigs is mounted to one support unit, and FIG. 6 is a plan view showing the state in which a plurality of battery packs is mounted to respective jigs.

As shown in FIGS. 3 to 6, the apparatus for manufacturing the battery pack assembly according to the present invention may include the above-described jig 200, a support unit 300, a hardening unit 400, an inspection unit 500, a washing unit 600, and a transfer unit 700.

The jig 200 was described in detail above, and therefore a description thereof will be omitted. The support unit 300, which is configured to support the entirety or a part of the battery pack 110 and the jig 200, may be formed in a flat circular shape having a predetermined area.

It is preferable for a plurality of jigs 200 to be seated on an upper surface of the support unit 300, and it is more preferable for an opening 230 of the jig 200 to be disposed so as to face outwards. The reason for this is that it is possible to easily mount the battery pack 110.

In particular, when a support shaft 310 is provided at a lower surface of the support unit 300 such that the support unit 300 is rotatable in a clockwise direction or a counterclockwise direction, there is an advantage in that it is possible to more easily mount the battery pack 110.

Of course, the support shaft 310 may be omitted, and therefore it is possible to mount the battery pack 110 to the jig 200 even though the support unit 300 is not rotated, and mounting of the battery pack 110 is not particularly restricted as long as the battery pack 110 can be moved to a desired position, for example the battery pack 110 can be manually mounted to the jig or an upper surface of the battery pack 110 can be suctioned using a suction plate and then the battery pack can be seated on the jig 200.

Although four jigs 200 are shown as being seated on the upper surface of the support unit 300 in the figures, which, however, is merely an example, the number of jigs 200 may be changed without limit.

The hardening unit 400 is configured to harden a polymer resin with which the jig 200 is filled. As an example, when an ultraviolet (UV) curing agent is contained in an epoxy resin, of which the shock absorption member 120 is made, the hardening unit may be a chamber having a UV lamp (not shown), and when a thermosetting resin is used, the hardening unit may be a chamber having a heat source (not shown) capable of heating the thermosetting resin to a predetermined temperature.

The inspection unit 500, which is configured to determine whether the shock absorption member 120 integrally formed with the battery pack 110 as the result of the polymer resin being hardened, i.e. the battery pack assembly 100, is defective, may be a vision camera; however, the present invention is not limited thereto, and it is possible for a worker to determine whether the battery pack assembly is defective with the naked eye or by hand.

Of course, in the inspection unit 500, the battery pack 110 is separated using a means identical or similar to the means that mounts the battery pack.

The washing unit 600, which is configured to remove some polymer resin remaining in the jig 200, may be a chamber having a high-pressure washing nozzle (not shown) provided at an upper surface or a side surface thereof.

The transfer unit 700, which is configured to sequentially transfer the support unit 300 having the plurality of jigs 200 seated thereon to the hardening unit 400, the inspection unit 500, and the washing unit 600, may be a conveyor belt; however, the present invention is not limited thereto.

As described above, the battery pack assembly manufacturing apparatus according to the present invention has a merit in that the support unit 300 having the jigs 200 seated thereon is sequentially moved to the hardening unit 400, the inspection unit 500, and the washing unit 600 by the transfer unit 700, which is formed in a closed loop shape, whereby mass production is possible and furthermore work can be rapidly performed.

Next, a method of manufacturing the battery pack assembly according to the present invention will be described.

The manufacturing method according to the present invention includes a first step of seating the battery pack 110 on a jig 200, a second step of filling the jig 200 with a polymer resin such that the polymer resin is located along one side of the battery pack 110, a third step of hardening the polymer resin such that a shock absorption member 120 is formed at one side of the battery pack 110, a fourth step of separating the battery pack 110 having the shock absorption member 120 formed thereon from the jig 200, and a fifth step of washing the jig 200 in order to remove the polymer resin remaining in the jig 200.

Meanwhile, a step of printing an upper surface of the battery pack 110 with a UV curable material may be further performed between the first step and the third step. In general, various kinds of information about the battery pack, such as date of manufacture, is printed on one side surface of the battery pack. It is preferable to print the above information after seating of the battery pack 110, and it is more preferable for a printing material to be UV curable paint.

The reason for this is that, when the material for the shock absorption member 120 is a UV curable resin, it is possible to simultaneously harden the polymer resin and the printing material in the third step of hardening the polymer resin.

In addition, a step of inspecting the battery pack assembly may be further performed between the third step and the fifth step. For example, a vision camera or a worker inspects whether the battery pack assembly is defective before or after the battery pack 110 having the shock absorption member 120 formed thereon is separated from the jig 200.

The battery pack assembly according to the present invention may be used in a device, for example a mobile device, such as a cellular phone; however, the present invention is not limited thereto.

Although the specific details of the present invention have been described in detail, those skilled in the art will appreciate that the detailed description thereof discloses only preferred embodiments of the present invention and thus does not limit the scope of the present invention. Accordingly, those skilled in the art will appreciate that various changes and modifications are possible, without departing from the category and the technical idea of the present invention, and it will be obvious that such changes and modifications fall within the scope of the appended claims.

### DESCRIPTION OF REFERENCE NUMERALS

100: Battery pack assembly
110: Battery pack
111: Power connector
120: Shock absorption member
121: Air pocket portion
200: Jig
210: Bottom plate
220: Side wall
230: Opening
240: Air formation bar
300: Support unit
310: Support shaft
400: Hardening unit
500: Inspection unit
600: Washing unit
700: Transfer unit

1. A battery pack assembly comprising:
a battery pack; and
a shock absorption member provided at one side of the battery pack.

2. The battery pack assembly according to claim 1, wherein the shock absorption member comprises a polymer resin and an air pocket portion.

3. An apparatus for manufacturing the battery pack assembly according to claim 1, the apparatus comprising:
a jig configured to be filled with a polymer resin so that the shock absorption member is formed at one side of the battery pack;
a support unit configured to support the battery pack and the jig, the support unit having a predetermined area; and
a hardening unit configured to harden the polymer resin with which the jig is filled,
wherein the jig comprises:
a bottom plate having a predetermined area,
side walls extending along an edge of the bottom plate by a predetermined height,
an opening provided in any one of the side walls so that one side edge of the battery pack is seated on the bottom plate, and
an air formation bar located among the side walls in a state in which one side surface of the air formation bar is contact with the bottom plate.

4. The apparatus according to claim 3, wherein a plurality of jigs including the jig are seated on an upper surface of the support unit.

5. The apparatus according to claim 4, wherein the support unit is rotatable in a clockwise direction or a counterclockwise direction, the support unit being formed in a circular shape.

6. The apparatus according to claim 3, further comprising a washing unit configured to remove the polymer resin remaining in the jig and the support unit after the battery pack having the shock absorption member formed thereon is separated from the jig.

7. The apparatus according to claim 3, wherein the polymer resin is a UV curable resin.

8. A method of manufacturing the battery pack assembly according to claim 1, the method comprising:
a first operation of seating the battery pack on a jig;
a second operation of filling the jig with a polymer resin so that the polymer resin is located along one side of the battery pack; and
a third operation of hardening the polymer resin so that a shock absorption member is formed at the one side of the battery pack,
wherein the jig comprises:
a rectangular bottom plate having a predetermined area,
side walls extending along an edge of the bottom plate by a predetermined height,
an opening provided in any one of the side walls so that one side edge of the battery pack is seated on the bottom plate, and
an air formation bar located among the side walls in a state in which one side surface of the air formation bar is in contact with the bottom plate, and
wherein an inside of each of the side walls is filled with the polymer resin.

9. The method according to claim 8, further comprising a fourth operation of separating the battery pack having the shock absorption member formed thereon from the jig.

10. The method according to claim 9, further comprising a fifth operation of washing the jig in order to remove the polymer resin remaining in the jig.

11. The method according to claim 8, wherein;
the polymer resin is a UV curable resin, and
an operation of printing an upper surface of the battery pack with a UV curable material is further performed between the first operation and the third operation.

12. The method according to claim 10, wherein an operation of inspecting the battery pack assembly is further performed between the third operation and the fifth operation.
